(19) United States
(12) Patent Application Publication
(10) Pub. No.: US 2012/0197181 A1
(43) Pub. Date: Aug. 2, 2012

(54) Device for inoculating a veterinary product into a poultry bird's wing

(75) Inventors: Karl Grosbois, Les Ponts De Ce (FR); Ludovic Braud, Saint Remy La Varenne (FR); Anno Jorna, Avrille (FR)

(73) Assignee: DESVAC, Pellouailles-Les-Vignes (FR)

(21) Appl. No.: 13/185,335

(22) Filed: Jul. 18, 2011

(30) Foreign Application Priority Data
Feb. 1, 2011 (FR) 11/00298

(51) Int. Cl. A61D 7/00

(52) U.S. Cl. 604/22

(57) ABSTRACT

The invention pertains to a device for inoculating at least one veterinary product into at least one poultry bird, said inoculating having to be performed on the wing-web membrane situated in the front part of the wing and extending between the radius and the humerus of the wing, characterized in that the device comprises:
a jaw comprising an upper part and a lower part, these parts together demarcating a receiving space designed to receive said wing-web membrane;
a scarifying tool borne by a supporting element, said scarifying tool having a channel designed to deliver a dose of veterinary product,
means for dosing the veterinary product, connected firstly to a container of veterinary product and secondly to the channel of said scarifying tool,
   said jaw and/or said supporting element being movable towards each other and being designed to enable said scarifying tool to be brought into said receiving space.

### 1. FIELD OF THE INVENTION

The field of the invention is that of the designing and fabrication of devices for assistance with veterinary practices. More specifically, the invention pertains to a device for inoculating birds, and more particularly poultry birds with veterinary products according to a technique by which the veterinary products are inoculated into the poultry bird's wing.

In the field of poultry breeding, it is classic to have to administer veterinary products, and especially vaccines, to poultry birds.

### 2. PRIOR ART

For certain poultry birds and certain veterinary products, one method of inoculation consists in depositing the veterinary product on the membrane known as the wing-web membrane, situated in the front part of the wing and extending between the radius and the humerus of the wing. It must be noted that at this spot, the wing-web membrane has a relatively small thickness, of the order of 1 mm.

This method of inoculation, also called transfixion or “wing-web” inoculation is widely used for the live vaccine that can be administered only in this way, namely the vaccine against avian pox.

Avian pox is a worldwide disease caused by a DNA virus belonging to the Avipoxvirus genus of the Poxviridae family. Various species can be distinguished from an antigen viewpoint: fowlpox virus (Avipoxvirus galli), turkeypox virus (Avipoxvirus meleagridis), pigeonpox virus (Avipoxvirus columbae), canarypox virus (Avipoxvirus serini). Avian pox is a low-contagion disease affecting inter alia hens and turkeys. This disease is characterized by the presence of diphtheria lesions in the gastrointestinal and upper respiratory mucosal lining. Vaccination against this disease is very important in breeding because it has a heavy economic impact. Indeed, avian pox causes a drop in egg laying and affects growth performance in birds.

In addition, for many years now, pox viruses and especially avian pox virus are being seen to be remarkable vectors, through the achievements of genetic engineering, for inducing immunity against the foreign antigens for which they code. These vectors are also used to vaccinate poultry birds against many other diseases and by way of an example, we may cite the Vectormune®FP-LT by Ceva Santé Animale which contains a live fowlpox virus genetically modified to express infectious avian laryngotracheitis in vivo.

Thus, the wing-web method is widely used in poultry farming and is an integral part of vaccination campaigns to vaccinate poultry birds against either avian pox or other infectious diseases.

At present, this method of vaccination works as follows:
the operator grasps the poultry bird and unfolds one of its wings so as to reveal the wing-web membrane;

the operator dips a needle into a vaccine container, this needle having a groove that extends longitudinally and forms a sort of reserve for a dose of veterinary product;
the operator jabs and make the needle cross the bird's wing at said wing-web membrane on one or even two points (transfixion).

The veterinary product in the reserve of the needle gets deposited on either side of the needle in the wound made by the needle.

A method of vaccination, or more generally a method for administering a veterinary product, performed in this way, has several drawbacks, among them:
the manual administering of a veterinary product proves to be excessively lengthy and painstaking, especially as the number of poultry birds to be treated may be very great;
the administering of veterinary products is not done with high precision since the technique of dosing by means of the reserve in the needle turns out in practice to be imprecise or even random;
the needle used for the inoculation of veterinary products comes into contact successively with the birds and with the veterinary product contained in the container in which the needle is dipped, at the risk of polluting the container of veterinary product;
there is a risk that the operator might injure himself or herself with the needle.

The invention is aimed especially at overcoming these drawbacks of the prior art.

More specifically, it is a goal of the invention to propose a device for assistance in inoculating a veterinary product into a poultry bird's wing-web membrane, enabling the delivery of a precise and constant dose of veterinary products.

It is also a goal of the invention to provide a device of this kind for administering a veterinary product to a poultry bird with greater efficiency and more speedily than is the case with prior art solutions.

It is another goal of the invention to provide a device such as this that enables the operator to administer veterinary products in a safe and ergonomic way.

### 3. SUMMARY OF THE INVENTION

These goals as well as others that shall appear here below are achieved by means of the invention, an object of which is a device for inoculating at least one veterinary product into at least one poultry bird, said inoculating having to be performed on the wing-web membrane situated in the front part of the wing and extending between the radius and the humerus of the wing,

characterized in that the device comprises:
a jaw comprising an upper part and a lower part, these parts together demarcating a receiving space designed to receive said wing-web membrane;
a scarifying tool borne by a supporting element, said scarifying tool having a channel designed to deliver a dose of veterinary product,
means for dosing the veterinary product, connected firstly to a container of veterinary product and secondly to the channel of said scarifying tool,
   said jaw and/or said supporting element being movable towards each other and being designed to enable said scarifying tool to be brought into said receiving space.

A device according to the invention procures many advantages, among them:
it clearly provides assistance to the operator, enabling him to treat poultry birds more speedily and in improved conditions of comfort and safety;
it provides for a precise and constant dosing of the inoculated veterinary products;
it prevents risks of pollution of the veterinary products stored in the container by preventing direct contact between the scarifying means and the container;
in general, the circuit through which the veterinary product is conveyed into the device is isolated from any external environment (except, of course, for the passage through which it is delivered).

According to a preferred embodiment, the device comprises a tongue external to the jaw capable of working with one of the parts which are the lower part or the upper part of the jaw to stretch the membrane and/or to push back the wing feathers.

Thus, the efficiency of the inoculation performed is further improved, for the following reasons:
the wing-web membrane in the scarifying zone is stretched, thus ensuring that the scarifying tool will incise into the wing-web membrane in the desired manner (unlike the situation where the membrane is slack, and can then get deformed under the thrust of the scarifying tool with the risk that the incision will be done only partially);
the feathers are moved away from the scarifying zone, which tends to limit the risk that the veterinary product will be deposited on the feathers and not on the wound itself.

According to an advantageous solution, said tongue is deformable between a position outside the jaw and a position within the jaw against one of the parts of this jaw, namely the lower or upper part, to stretch the membrane and/or to push back the feathers on the wing.

Thus, as shall be explained in greater detail here below, the tongue has a position at rest outside the jaw, and when a poultry bird's wing is introduced into the jaw and when the operator imposes a relative shift between the jaw and the scarifying tool, the tongue will engage inside the jaw, so that it gets engaged in the space between the poultry bird's wing and the corresponding part of the jaw, thus causing the tongue to get deformed.

Advantageously, the tongue has a passage through which said scarifying tool is to be engaged.

Thus, it is ensured that the action of the tongue will not interfere with that of the scarifying tool.

According to a preferred embodiment, said supporting element extends beneath said jaw and at least the lower part of said jaw has a passage through which said scarifying tool is to be engaged.

It can be understood that, according to this embodiment, the treatment of the poultry bird will be done by a downward shift of the jaw towards the scarifying tool, this tool passing through the lower part of the jaw.

It is however possible to conceive of another embodiment in which the scarifying tool will be shifted downwards, towards the jaw, in passing through a passage made in the upper part of the jaw, and doing so by inverting the respective positions of the jaw and the scarifying tool.

Advantageously, said upper part has an hole extending in the alignment of the passage of said lower part of the jaw, this hole being preferably provided with an insert forming a stop for said scarifying tool.

Thus, at the end of its travel, the scarifying tool comes to a position of rest against the insert, this insert being designed to prevent premature wear and tear in the projecting parts of the scarifying tool.

According to a preferred approach, said scarifying tool has a tubular shape extending between a base carried by said supporting element and a scarifying end having at least one point.

The tubular shape combined with the presence of a point on this tool enables it to perform a dual function: that of enabling the scarification and that of enabling the conveyance of the product or products while it is connected to a circuit comprising the dosing means.

Preferably, said scarifying end has four points.

Thus, the number of incisions made by the scarifying tool is increased, increasing the contact surface of the veterinary products with the incisions just made.

According to one advantageous embodiment, the device has a frame, the supporting element being mounted fixedly to said frame while said jaw is mounted movably on said frame so that it can be moved towards or away from said supporting element.

It can therefore be understood that, in this configuration, it is the jaw that is shifted towards the supporting element. Such a configuration proves to be particularly advantageous should the jaw be placed above the supporting element, it being possible for a downward thrust of the machine to be exerted simply and through a relatively natural gesture on the part of the operator in order to treat the poultry bird.

In this case, said driving means can be actuated manually and/or assisted by means known to those skilled in the art such as for example a pneumatic pump controlled by a foot-operated or pedal command.

Advantageously, a lever designed to be manually actuated is mounted on a secondary arm that is movable integrally with said jaw in one direction of shift, said supporting element extending in said direction of shift between the arm and the jaw.

Such a lever can then be maneuvered by a thrust directly exerted by the operator.

In one particular embodiment, said jaw is borne by a primary arm and said supporting element has a trough-shaped portion in which said primary arm is guided.

Preferably, said lever has an end provided with a plate designed to form a resting surface.

In a preferred solution, the upper and lower parts of the jaw are spaced out from one another by a height designed so that a radius and/or a humerus of a bird's wing abut them.

In an advantageous solution, said dosing means include a micro-pump mounted on said supporting element.

Advantageously, said container is mounted on said supporting element.

The container can thus be mounted on a zone of the device in which it is easy to control the level of veterinary product contained in the container and in which the container can easily be replaced or filled.

According to an advantageous solution, the device includes a set of at least two jaws, each being appropriate, in terms of dimensions of receiving space, to a wing morphology which evolves with the age of the poultry bird, the receiving space of one of the jaws being for example greater, at least in height, than the receiving space of the other jaw.

Thus, it is possible to have different jaws, each one being appropriate, in terms of dimensions of the receiving space, to a wing morphology which changes with the age of the poultry bird (especially as regards the thickness of the membrane, of the muscles and of the bone structure).

Preferably, the device of the invention is used for poultry birds chosen from among hens, ducks or turkeys.

According to a first advantageous application, a device according to the invention is used to vaccinate poultry birds against avian pox and for the application of all types of vaccine suited for application by wing-web inoculation or scarification.

According to a second advantageous application, a device according to the invention is used for administering a vaccine to poultry birds, this vaccine comprising an avian pox virus genetically modified to express in vivo the antigens of one or more infectious diseases. In this case, the infectious diseases are chosen from among the group constituted by Newcastle disease, infectious laryngotracheitis, avian encephalomyelitis, and avian mycoplasma.

### 4. LIST OF FIGURES

Other features and advantages of the invention shall appear more clearly from the following description of a preferred embodiment of the invention, given by way of an illustrative and non-exhaustive example, and from the appended drawings, of which:

the FIGS. 1 and 2 are each a view in perspective and a general view of a device according to the invention;

FIGS. 3 and 4 are a partial view in perspective of a device according to the invention;

FIG. 5 is another partial view in perspective of a device according to the invention, during operation;

FIGS. 6 and 7 illustrate two different jaws that could be fitted into a device according to the invention;

FIG. 8 is an anatomical representation of a poultry bird's wing.

### 5. DETAILED DESCRIPTION OF THE INVENTION

As indicated here above, the principle of the invention consists in proposing a device to carry out an inoculation of at least one veterinary product into a poultry bird.

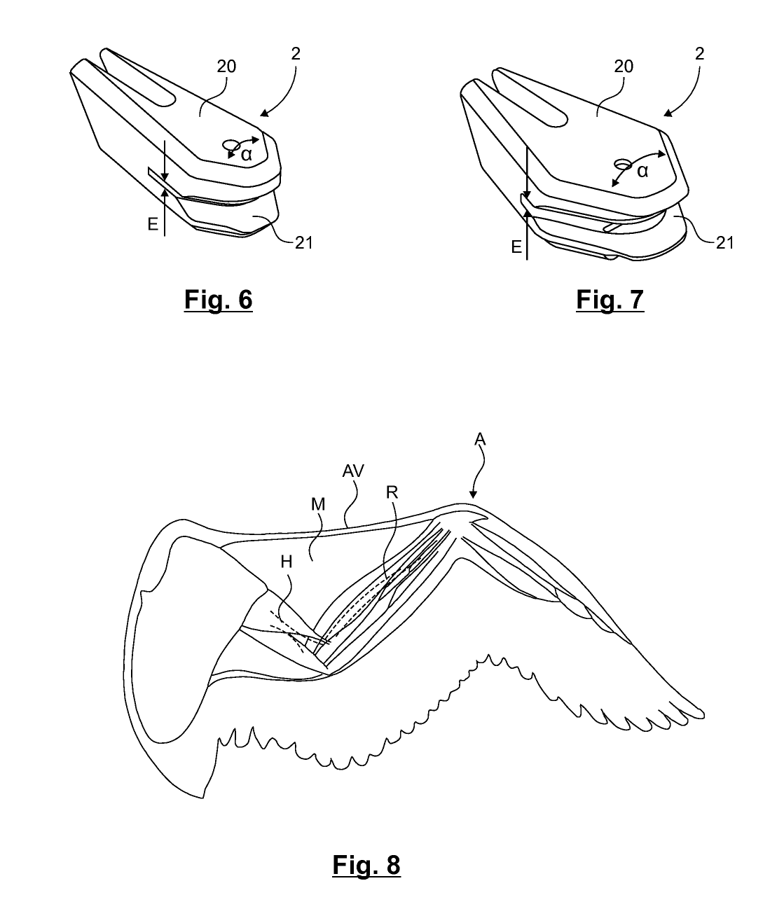

Referring to FIG. 8, such an inoculation is performed in the context of the invention on the wing-web membrane M situated in the front part AV of the wing A and extending between the radius R and the humerus H of the wing.

Referring to FIGS. 1 and 2, a device according to the invention comprises:
a frame 1 containing, according to the present embodiment, a streamlined assembly provided with several accessories described in greater detail here below;
a jaw 2 within which a poultry bird's wing has to be placed in order to be inoculated with a veterinary product;
a scarifying tool 30 borne by a supporting element 3;
means 4 for dosing out the veterinary product and a container 40 attached to the device (detachably with a view to its replacement) and connected (also detachably) to the dosing means.

In addition, the jaw 2 and/or the supporting element 3 are movable relatively to each other and are designed to enable the scarifying tool 230 to be brought into contact with a poultry bird's wing placed in the jaw 2 with a view to incising the membrane referred to here above.

As indicated in FIG. 1, the jaw 2 has a receiving space 22 designed to receive the wing-web membrane situated in the front part of the wing extending between the radius and the humerus of the wing, this receiving space being demarcated between an upper part 20 and a lower part 21 of the jaw.

The upper and lower parts of the jaw 2 are positioned relatively to one another so as to have a spread between them planned in such a way that the receiving space is adjusted in height approximately at the thickness of the wing-web membrane that is to be introduced into the jaw. In any case, the upper and lower parts 20, 21 of the jaw are spaced out relatively to each other by a height smaller than the height of the radius and/or humerus of the bird's wing.

It must be noted that the receiving space thus made is restricted in height to the extent of not allowing the operator to introduce a finger into the receiving space.

Furthermore, the depth of the receiving space is sized in a particular way. Indeed, the receiving space is designed so that the entire wing-web membrane of the bird, in its front-to-rear dimension, takes position in the receiving space. Consequently, the radius and/or the humerus abut the upper and lower parts of the jaw at its entrance once the membrane has been accurately positioned inside the jaw or, in other words, completely engaged from front to rear between the upper and lower parts of the jaw.

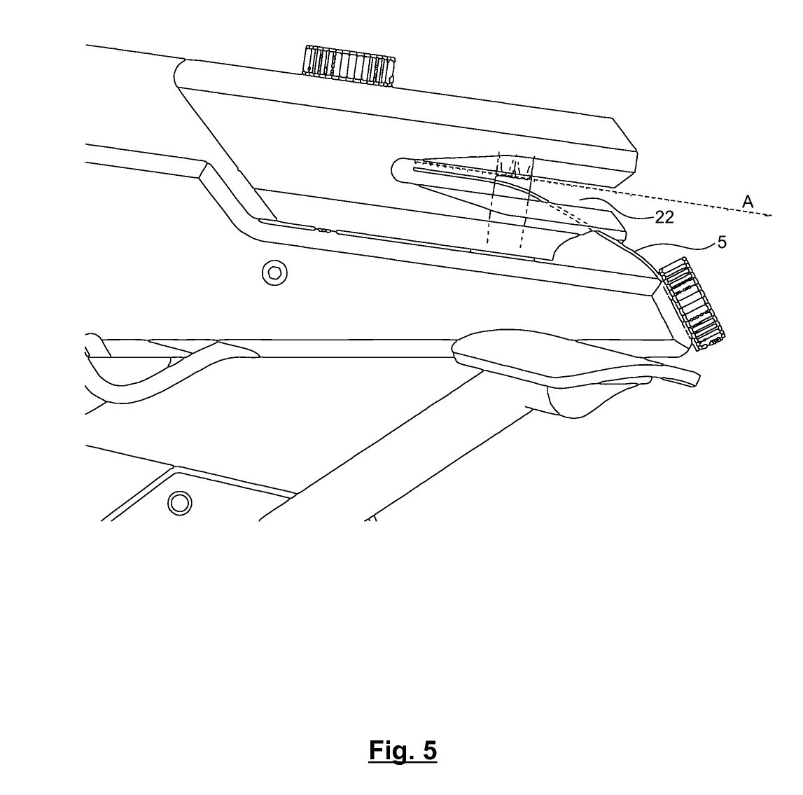

It can be noted that the end shape of the upper and lower parts of the jaw may vary: they may have a rounded shape at their free end as shown in FIG. 2 or a more angular shape (even though it may be constituted by curves) as illustrated by FIGS. 6 and 7, adapted to the angle formed by the radius and the humerus of the wing, enabling the wing-web membrane to be better centered in the jaw.

In addition, referring to FIGS. 6 and 7, a device according to the invention can be proposed with a set of several jaws, for which the values of the spacing E between the upper part 20 and the lower part 21 are different from one another and for which the angle α can vary from one another. Thus, the operator can choose one jaw or another as a function of the bird's age and morphology so that receiving space is made most appropriate to the thickness of the wing-web membrane. Furthermore, the use of the most appropriate jaw gives the best possible securing of the wing bones (radius and humerus) against the upper and lower parts of the jaw.

Furthermore, as illustrated in FIGS. 1 to 4, the scarifying tool 30 has a tubular shape extending between a base 31 borne by the supporting element 3 and a scarifying end having at least one point, the scarifying tool according to the present embodiment having four points 301.

In addition, the scarifying tool 30 has a channel 302 in the shape of an axial hollowed portion opening out at each end of the scarifying tool. This channel 32 is designed to deliver a dose of veterinary product on and/or beneath the wing-web membrane, once the scarifying tool has incised the wing-web membrane placed in the jaw and while the scarifying tool is held between the upper part 20 and the lower part 21 of the jaw.

It can be noted that the delivery of the dose of veterinary product can be prompted just before, during or just after the scarifying of the membrane by the tool of the device.

As can be seen in FIGS. 1 and 2, the dosing means 4 are constituted by a micro-pump mounted on the supporting element 3. A micro-pump of this kind is an element known to those skilled in the art. As it happens, the micro-pump used is sized so as to deliver 0.01 ml doses.

The container 40 of veterinary product is also for its part mounted on the supporting element 3, on the face of the supporting element opposite the one carrying the dosing means. The container 40 is connected to the dosing means by a flexible conduit 41. Another conduit 42 connects the dosing means 4 to the scarifying tool 30, this conduit 42 communicating with the channel 302 of the scarifying tool in passing through the supporting element 30 by means of a passage 310 (FIG. 4) provided for this purpose.

According to the present embodiment of the invention, the device has a configuration according to which:
the supporting element 3 extends beneath the jaw 2;
the supporting element is mounted so as to be fixed to the frame 1 while the jaw is carried by the primary arm 23 mounted movably on the arm 1, in such a way that the jaw 2 can be brought closer to or moved away from the scarifying tool (the points of which are therefore pointed upwards).

In this configuration, it can be noted that:
the lower part 21 of the jaw has a hole 210 sized and positioned so as to enable the passage of the scarifying tool 30 in order to bring it into the receiving space 22 demarcated between the lower part and the upper part of the jaw;
the upper part of 20 of the jaw has an hole 200, coaxial with the hole 210 of the lower part, making it possible to take the scarifying tool beyond the receiving space 22, and doing so in penetrating the upper part.

Furthermore, the hole 200 is provided with an insert 201 (shown in dashes in FIG. 4) forming a stop for the scarifying tool. This insert herein takes the form of a washer, which may or may not be deformable, against which the points of the scarifying tool are to rest.

According to one possible variant, the insert can also take the form of a truncated part against which the scarifying tool abuts in being coaxial with the truncated part, this part being designed so that its end with the smallest diameter gets placed, at the end of travel, between the points of the scarifying tool while the points abut the external surface of the truncated part.

According to one other characteristic of the invention, the device comprises driving means designed to be actuated in this case by hand in order to shift the jaw 2 towards the supporting element 3.

As can be seen in FIGS. 1 and 4, these driving means include:
a secondary arm 60 that is movable integrally with the jaw 2 in the direction of shift D of the jaw towards the scarifying tool (this direction of shift D being shown in dashes in FIG. 4 and corresponding according to the present embodiment to a curve passing through the center of the hole 200 of the upper part 20 of the jaw, through the center 210 of the lower part 21 of the jaw and through the central point between the four points of the scarifying tool), the secondary arm 60 extending beneath the supporting element 3 in such a way that, according to the present embodiment, the supporting element 3 extends between the secondary arm and the jaw in the direction of shift;
a lever 6, mounted in an hole 600 of the secondary arm 60 so as to extend perpendicularly in a direction horizontal to the secondary arm, this lever having a plate 61 at its free end designed to form a resting surface either for the operator's hand or for the poultry bird's body (in this case the operator drives the lever and the bird together downwards).

In this configuration, it can be understood that the median plane of the primary arm, the median plane of the secondary arm and the median plane of the supporting element, all containing the direction of shift D, coincide with one another.

It must be noted that the lever 6 can be mounted equally well on either side of the secondary arm, depending on the lateralization of the operator, making it possible in other words for the lever to be positioned to the left or to the right of the device.

Furthermore, the primary arm bearing the jaw and the secondary arm bearing the lever are both mounted so as to be fixed on a common arm (not shown) pivoting on a fixed part of the frame.

Moreover, as can be seen in FIG. 2, a return spring 32 is connected by one of its ends to the primary arm 23 and by its other end to the supporting element 3. A spring of this kind is designed to work in compression: when the primary arm is driven downwards (under the effect of a downward thrust exerted on the lever 6) the spring 32 is compressed. The result of this is that, when the thrust on the lever is relaxed, the spring tends to bring the primary arm back into a resting position at a distance from the supporting element.

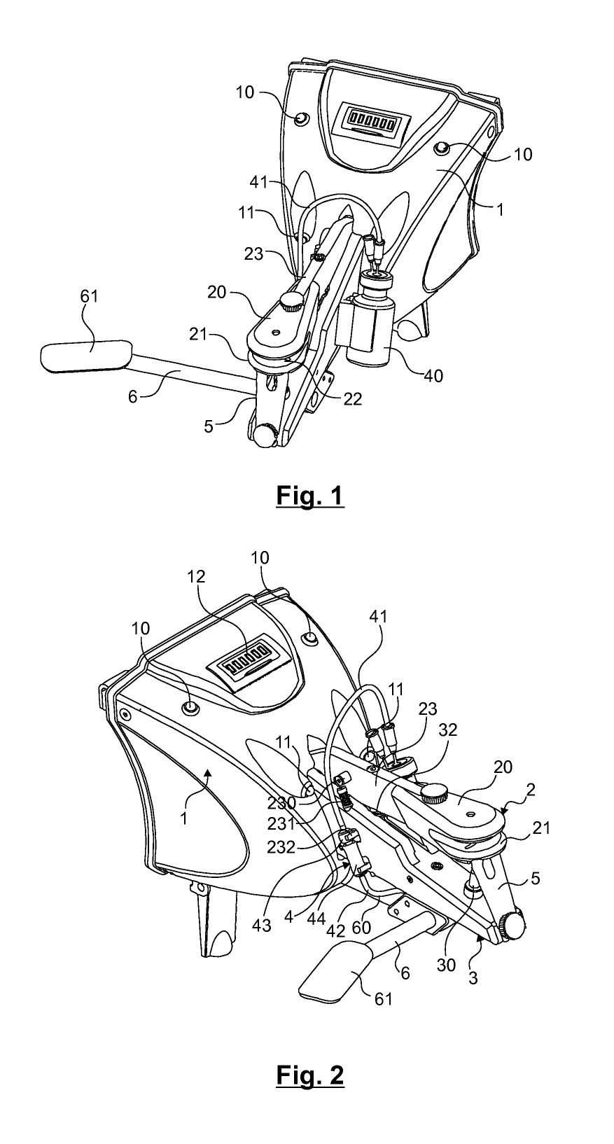

Referring to FIG. 3, it can also be noted that the supporting element 3 has, on a portion of its length, a shape of a trough 33 in which the primary arm 23 is guided laterally. Indeed, in the bottom position of the primary arm, this arm is contained in the trough 33.

It can furthermore be noted that the jaw 2 is made in the shape of a point fixed to the end of the primary arm 23, this point forming a protrusion. The trough 33 ends in a zone coinciding with the start of the protrusion formed by the jaw 2 when the arm 23 is in a low position.

To another characteristic of the invention, the device comprises a tongue 5, external to the jaw 2 and capable of cooperating with one parts, namely the lower part and the upper part, of the jaw. According to the present embodiment illustrated by FIGS. 1 to 4, the tongue is mounted at the end of the supporting element 3 and extends upwards in an oblique direction towards the jaw 2.

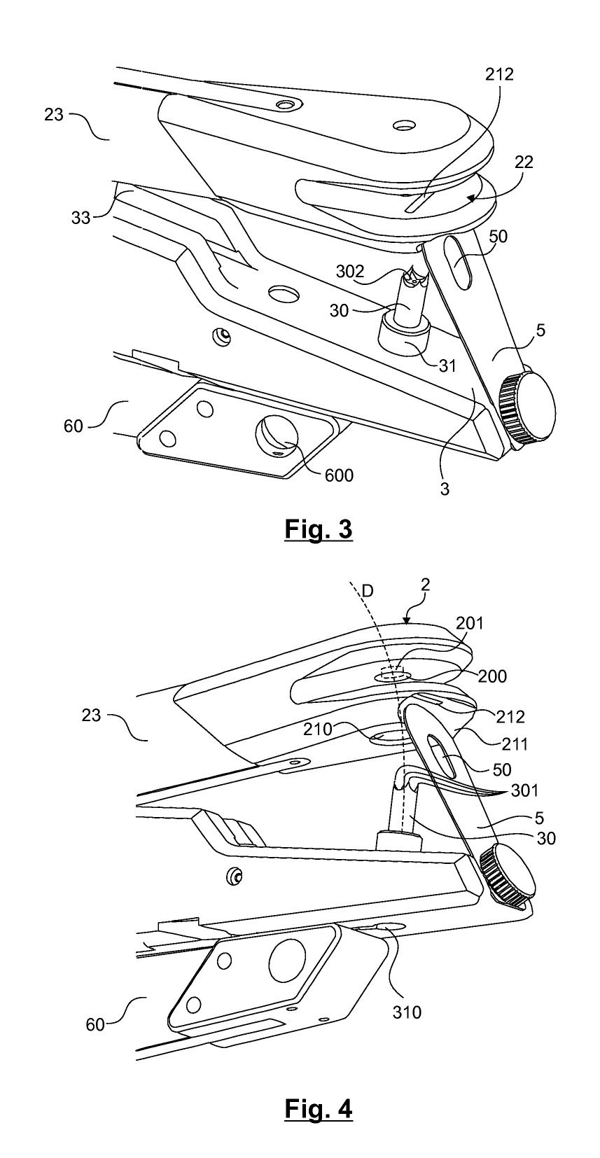

This tongue 5 is made out of a deformable material and has a thickness enabling it to bend from a position such as the one illustrated in FIGS. 3 and 4, in which it extends out of the receiving space 22 of the jaw, to a position in which it partly extends into the receiving space 22 of the jaw, to a position according to which it partly extends into the receiving space 22 between the lower part of the jaw 2 and a poultry bird's wing A (as illustrated in FIG. 5).

Moreover, the lower part 21 of the jaw 2 has, at its free end, a cavity 211, a slot 212 going through the lower part of the jaw and opening firstly into the cavity 211 and secondly into the receiving space 22. This slot is capable of and designed to let the tongue 5 pass through the lower part of the jaw.

The supporting element 3 also has a length starting from the frame that is greater than the length of the assembly formed by the primary arm and the jaw 2. The tongue 5 is mounted by its base to the end of the supporting element and extends obliquely toward the slot 212 which is located at a distance from the frame that is smaller than the distance between the tongue and the frame.

It can be noted that the slot 212 is made in such a way that it goes through the lower part of the jaw in a direction that almost coincides with the direction corresponding to the inclination of the tongue 5.

It can furthermore be noted that the tongue 5 has a hollowed portion 50 forming a passage through which the scarifying tool 30 is to get engaged when the jaw is in a position close to the supporting element 3.

This hollowed portion 50 has an oblong shape which enables the hollowed portion to be placed so as to correspond with the hole 210 of the lower part 21 of the jaw, in doing so without making it necessary to position the tongue precisely in relation to the lower part of the jaw.

The working of a device according to the invention in its embodiment described here above is as follows.

The operator seizes a poultry bird and spreads out one of the wings away from the bird so as to reveal the wing-web membrane situated in the front part of the wing and extending between the radius and the humerus of the wing.

This cleared part of the membrane is introduced into the jaw 2, between the lower part and the upper part of the jaw which demarcates the receiving space.

The poultry bird's body is presented in such a way that the bottom of the wing is pointed downwards.

While the operator keeps the poultry bird with its wing engaged in the jaw of the device, he or she prompts a downward shift of the lever 6 by directly or indirectly pushing on the plate 61 of the lever.

The descent of the lever is accompanied simultaneously by the descent of the primary arm 23 and therefore, of the jaw 2 towards the supporting element 3. As and when this descent takes place, the scarifying tool gets engaged in the hole 210 of the lower part of the jaw. At the same time, the tongue 5 gets engaged in the slot 212 of the lower part of the jaw.

The descent continues in such a way that the tongue 5 is constrained so as to get deformed in bending so as to take position in the receiving space between the poultry bird's wing and the lower part of the jaw.

The receiving space is given a height so that the tongue 5 is placed in contact with the lower part on the one hand and in contact with the poultry bird's wing on the other hand so as to:
push back the membrane towards the front of the wing, which amounts to stretching the membrane;
push back the feathers which may be present in the receiving space towards the front of the wing.

The length of the tongue 5 and the height of the scarifying tool are designed relatively to one another in such a way that the tongue is in position in the receiving space (i.e. with the hollowed portion 50 brought so as to coincide with the hole 210 of the lower part of the jaw) before the scarifying tool 30 opens out from the lower part into the receiving space.

The descent of the jaw then continues a little until the points of the scarifying tool pass through the membrane, doing so until they penetrate the hole 200 of the upper part 20 of the jaw. The points of the scarifying tool then come into contact with the deformable insert 201 placed inside the hole 200 of the upper part of the jaw.

At this stage, a dose of veterinary product is drawn in from the container 40 by the micro-pump 4, this dose of veterinary product being sent through the conduit 42 into the scarifying tool until it is deposited on the wing and/or beneath the wing (the membrane being very thin at this point in the wing). It may be recalled that the delivery of the dose of veterinary product can be done equally well just before or during or just after the incision of the wing by the scarifying tool.

As can be seen in FIG. 2, the micro-pump has a chamber 44 and a piston 43 laid out in a manner known per se so that a partial withdrawal of the piston out of the chamber causes a suction of product while a thrust of the piston into the chamber causes the product present in the chamber to be expelled out of the chamber. Furthermore, the primary arm 23 has a finger 230 coupled to a rod 231 (surrounded by a spring that helps to draw the rod back in the high position) which extends in a passage crossing the wall of the supporting element 3 up to a second finger 232 fixedly joined to the piston 43 of the micro-pump. Thus, the upward shift of the primary arm (while the supporting element 3 remains fixed) gives rise to a suction of product into the chamber and the downward shift of the primary arm (while the supporting element 3 remains fixed) causes product to be expelled toward the scarifying tool.

The action on the lever by the operator can then be relaxed. The spring 32 then causes the primary arm to return to its rest position, at a distance from the supporting element 3.

Furthermore, the frame has several functional organs, namely:
two LEDs 10, at the upper part of the frame, giving the operator a control means: the two LEDs 10 could for example be simultaneously green when the device is addressed while they could be simultaneously red when the downward movement of the jaw is done correctly for inoculating the bird with the veterinary product;
two light-emitting diodes or LEDs 11 placed partially before the frame and oriented so as to enable an illumination of the scarifying area;
a counter 12 designed to display the number of doses of veterinary product delivered.

According to a preferred embodiment, the device of the invention is used to vaccinate poultry birds against avian pox.

According to another embodiment of the invention, the device is used to vaccinate poultry birds by the inoculation of genetically modified avian pox viruses to express antigens of one or more infectious diseases (vector vaccines) in vivo.

Preferably but not exhaustively, the genetically modified pox viruses express in vivo the antigens of Newcastle disease, infectious laryngotracheitis, avian encephalomyelitis or avian mycoplasmas.

According to an advantageous embodiment, the device of the invention is used to vaccinate poultry birds and more particularly hens, ducks and turkeys.

1. A device for inoculating at least one veterinary product into at least one poultry bird, said inoculating having to be performed on the wing-web membrane situated in the front part of the wing and extending between the radius and the humerus of the wing, wherein the device comprises:
a jaw comprising an upper part and a lower part, these parts together demarcating a receiving space designed to receive said wing-web membrane;
a scarifying tool borne by a supporting element, said scarifying tool having a channel designed to deliver a dose of veterinary;
means for dosing the veterinary product, connected firstly to a container of veterinary product and secondly to the channel of said scarifying tool;
said jaw and/or said supporting element being movable towards each other and being designed to enable said scarifying tool to be brought into said receiving space.

2. The device according to claim 1, wherein the device comprises a tongue external to the jaw capable of working with one of the parts which are the lower part or the upper part of the jaw to stretch the membrane and/or to push back the wing feathers.

3. The device according to claim 2, wherein said tongue is deformable between a position outside the jaw and a position within the jaw.

4. The device according to claim 2, wherein said tongue has a passage through which said scarifying tool is to be engaged.

5. The device according to claim 1, wherein said supporting element extends beneath said jaw and in that at least the lower part of said jaw has a passage through which said scarifying tool is to be engaged.

6. The device according to claim 5, wherein the upper part of said jaw has an hole extending in the alignment of the passage of said lower part of the jaw.

7. The device according to claim 6, wherein said hole is provided with an insert forming a stop for said scarifying tool.

8. The device according to claim 1, wherein said scarifying tool has a tubular shape extending between a base carried by said supporting element and a scarifying end having at least one point.

9. The device according to claim 8, wherein that said scarifying end has four points.

10. The device according to claim 1, wherein the device comprises a frame, said supporting element being mounted fixedly to said frame while said jaw is mounted movably on said frame so that it said jaw can be moved towards or away from said supporting element.

11. The device according to claim 10, wherein the device comprises driving means that are manual and/or assisted in order to shift the jaw and/or said element towards each other.

12. The device according to claim 11, wherein said driving means comprise are a lever mounted on a secondary arm that is movable integrally with said jaw in one direction of shift, said supporting element extending in said direction of shift between said secondary arm and said jaw.

13. The device according to claim 12, wherein said jaw is borne by a primary arm and said supporting element has a trough-shaped portion in which said primary arm is guided

14. The device according to claim 12, wherein said lever has an end provided with a plate designed to form a resting surface.

15. The device according to claim 1, wherein the upper and lower parts of the jaw are spaced out from one another by a height designed so that a radius and/or a humerus of a bird's wing abut them.

16. The device according to claim 1, wherein said dosing means include a micro-pump mounted on said supporting element.

17. The device according to claim 1, wherein said container is mounted on said supporting element.

18. The device according to claim 1, wherein the device comprises a set of at least two jaws, each being appropriate, in terms of dimensions of receiving space, to a wing morphology which changes with the age of the poultry bird.

19. The device according to claim 1, wherein the at least one poultry birds are bird is chosen from among hens, ducks and turkeys.

20. A method comprising:
vaccinating poultry birds against avian pox, the birds having a wing with a wing-web membrane situated in a front part of the wing and extending between a radius and a humerus of the wing; and
performing the step of vaccinating on the wing-web membrane using a device comprising:
a jaw comprising an upper part and a lower part, these parts together demarcating a receiving space designed to receive said wing-web membrane;
a scarifying tool borne by a supporting element, said scarifying tool having a channel designed to deliver a dose of veterinary product; and
a device for dosing the veterinary product, connected firstly to a container of veterinary product and secondly to the channel of said scarifying tool, said jaw and/or said supporting element being movable towards each other and being designed to enable said scarifying tool to be brought into said receiving space.

21. A method comprising:
administering a vaccine to poultry birds, the birds having a wing with a wing-web membrane situated in a front part of the wing and extending between a radius and a humerus of the wing, the vaccine comprising an avian pox virus genetically modified to express in vivo the antigens of one or more infectious diseases; and
performing the step of administering on the wing-web membrane using a device comprising:
a jaw comprising an upper part and a lower part, these parts together demarcating a receiving space designed to receive said wing-web membrane;
a scarifying tool borne by a supporting element, said scarifying tool having a channel designed to deliver a dose of veterinary product; and
a device for dosing the veterinary product, connected firstly to a container of veterinary product and secondly to the channel of said scarifying tool, said jaw and/or said supporting element being movable towards each other and being designed to enable said scarifying tool to be brought into said receiving space.

22. The method according to claim 21, wherein the infectious diseases are chosen from among the group consisting of Newcastle disease, infectious laryngotracheitis, avian encephalomyelitis, and avian mycoplasma.
